(19) United States
(12) Patent Application Publication
(10) Pub. No.: US 2024/0058724 A1
(43) Pub. Date: Feb. 22, 2024

(54) Pressure Gradient Seawater Distillation System

(71) Applicant: Rolf Joachim Mehlhorn, Richmond, CA (US)

(72) Inventor: Rolf Joachim Mehlhorn, Richmond, CA (US)

(21) Appl. No.: 18/448,801

(22) Filed: Aug. 11, 2023

Related U.S. Application Data
(60) Provisional application No. 63/371,835, filed on Aug. 18, 2022.
(60) Provisional application No. 63/383,655, filed on Nov. 14, 2022.

(51) Int. Cl. B01D 5/00; C02F 1/04; C02F 1/14; B01D 1/00; B01D 1/02

(52) U.S. Cl. CPC B01D 5/0027; C02F 1/048; C02F 1/14; B01D 1/0035; B01D 1/02; B01D 5/006; B01D 5/0084; B01D 5/0087; B01D 5/009; B01D 5/0075; C02F 2103/08

(57) ABSTRACT

A Pressure Gradient Seawater Distillation System for distilling a fluid. The elements of the system are positioned to transmit heat to improve efficiency. Fluid enters an entry tube, cooling a photovoltaic panel and cooling water in an intermediate tube. The entry tube deposits fluid in an evaporator, where the fluid is heated to transform into a gas. The gas is transmitted to a condensing chamber, where the pressure is varied to assist in condensation. Condensed water is stored in a reservoir, where a splitter is used to transmit a portion of the excess water to an exit point, while the remainder of the water is cooled by heat exchange and transmitted to a nozzle in the condensing chamber. Water falls from the nozzle to capture water vapor in condensing the gas in the condensing chamber or in condensing regions of a single compartment distiller. A flow control element, a pressure valve, and pressure controls are included for managing fluid flow and pressure.

### FIELD OF THE INVENTION

The present invention relates generally to water distillation systems. Specifically, the present invention is a seawater distillation system using a pressure-operated chamber.

### BACKGROUND OF THE INVENTION

Distilled water has high value as drinking water or in some industrial operations. A lesser value is its use in ameliorating adverse effects of otherwise hazardous water, e.g. water sourced from moderately saline aquifers. Evaporative and condensation strategies for water distillation have had limited utility in prior water distillation efforts, and have often failed due to the difficulty of maintaining adequate temperature gradients in open systems. In addition, it is well-established that solar panel performance decreases with high temperatures associated with full sun illumination, so there exists a need for improved cooling mechanism for solar panel systems.

The present invention aims to solve the above issues by providing a pressure gradient seawater distillation system. Seawater is heated to produce humid air or steam, which passes into a pressure-tolerant chamber and condenses onto relatively cool water droplets comprising an effectively large surface area that allows for rapid condensation of water vapor as the “rain drops” gain volume and become warmer as they descend into a distilled water collector. The system has the potential for relatively massive transfer of pure water when the water vapor phase is pressurized. The change in pressure can greatly assist in the condensation of the water vapor, providing much faster and more efficient distillation of salt water or other fluids.

Rapid transformation of gas-to-liquid phase transformation derives from the potential of much higher surface area on the volume fraction of small water droplets than would be possible with solid condensing surfaces, e.g. metal tubes. Also, small-diameter tubular condensation arrays require significant mechanical work to overcome friction associated with coolant motion. Effective water vapor volume with the falling drop system is potentially much greater than one where condensation tubes (cooled by seawater flowing though their interior) occupy a substantial volume of the condensing chamber.

The present invention, after optimization of operating conditions, has the potential to be substantially more energy efficient than any known reverse osmosis or heat-recovery distillation systems. Favorable cost-benefit points include lower operating costs, particularly if solar thermal energy helps provide adequate temperature gradients for distillation, as water pumping costs are relatively low compared to heating/cooling operations associated with steam distillation or mechanical work associated with reverse osmosis (RO) pressure gradients.

Although the heat losses occur in the presently described system are not significant when compared to current seawater distillation systems which rely on energy-hungry pressure and heat exchange manipulations in multiple compartments, it is suggested that discharge of heated and decarbonized seawater into open, sunlight absorbing and shallow tiered reservoirs may afford other benefits, including the opportunity for relatively rapid brine recovery with significant economic value (magnesium, lithium, uranium, etc.).

Optimization of water vapor pressurization would have a substantial effect on the overall efficiency of distillation, as vapor condensation is associated with pressure reduction (this lowers or may fully avoid energy cost of pumping water) and distillate volumes per condensing container volume. Among parameters to be optimized would be maintenance of tolerable pressure maxima of the condensing chamber structure as well as optimization of water vapor concentrations relative to ambient air. Some vapor discharge from the condensing chamber would prove advisable to avoid excessive accumulation of carbon dioxide and its associated effect on distillate and recovered brine pH (seawater vaporization would be associated with conversion of bicarbonate to CO2).

Higher distillation yield could result if some rain drops arise from aerosols; this may require energy intensive pumping into specialized water emitters at the top of the condensing chamber. Such “sprinkler optimization” could take advantage of pressure gradients arising from lowering residual air in the pressure chamber.

The present invention is an improved Pressure Gradient Seawater Distillation System, making use of pressure gradients to reduce the need for pumps in the system, using the pressure gradient to naturally assist in sustaining the cycle of water through the system. Additionally, the proper adjacency of countercurrent heat exchangers and water transit tubes in the system reduces energy requirements by cooling any solar panels while heating intake water, and cooling water being used in the condensing chamber. The formation of powerful pressure gradients as water vapor condenses onto falling water droplets in the condensing chamber further assists in optimizing the mass transfer of water vapor, allowing more efficient distillation.

### SUMMARY

The summary should not be construed to limit the scope of the invention in any manner, and is merely present for the purpose of assisting in understanding of the function and purpose of the present invention.

The present invention is a Pressure Gradient Seawater Distillation System. The pressure gradient seawater distillation system may comprise an evaporator, a condensing chamber, an entry tube, an intermediate tube, a water reservoir, a splitter, a photovoltaic panel, a vacuum pump, a system exit point, a flow control element, a pressure release whistle, and a pressure valve. The condensing chamber does not necessarily refer to an enclosed compartment; it could be a region within a large pressure-tolerant evaporation structure having a ceiling containing nozzles, which serve as water droplet dispensers. At the bottom of the structure, distilled water collectors or water reservoirs would be vertically aligned with the dispensers at the top. Such a configuration would not require capital and operating costs associated with separate structures and would likely be preferred for large-scale desalination efforts comprising seawater heated by solar thermal and electrical energy.

Water flows into the system from a water source into the entry tube, and may be accomplished via a pump, vacuum, through the use of a pressure differential, or similar mechanism. The water source is ideally salt water, though any fluid may be used. Ideally, the entry tube passes directly in contact with the photovoltaic panel, simultaneously cooling the photovoltaic panel to improve the energy efficiency of the photovoltaic panel while warming the water in the entry tube. In addition, the entry tube may be in contact with the intermediate tube to further transfer heat between water in the entry tube and water in the intermediate tube. As in current sea-water distillation schemes, mature heat exchange technology would play a key role in overall energy efficiency. However, in this new scheme, heat exchange also plays a vital role in producing cool raindrops that are recovered from some of the distillate.

The entry tube deposits the water into the evaporator. A heating coil in the evaporator heats the water to boiling, leaving behind alkaline brine. The boiling water releases steam, which then passes into the condensing chamber or single-chamber water droplet domains.

The vacuum pump may remove or add air into the condensing chamber to vary the pressure, improving the conditions to allow condensation within the condensing chamber.

One or more nozzles at the top of the condensing chamber dispense water in droplet form, falling from the top to the bottom of the condensing chamber. By coming in contact with the steam, the droplets from the nozzles further assist in condensation, pulling water from the steam in the air back into water form and falling to the bottom of the condensing chamber.

The water reservoir may be present at the bottom of the condensing chamber, and will store the distilled water that has been condensed from the steam. The distilled water from the water reservoir will then enter the intermediate tube. The water will be moved either by the natural pressure gradient formed from the removal of air earlier by the vacuum pump, or may be transmitted into the intermediate tube by a pump or similar fluid control device that is well-known in the art.

The intermediate tube connects the water reservoir to the nozzles at the top of the condensing chamber. In some embodiments, the water in the intermediate tube may be further cooled by passing the water in contact to the water in the entry tube, further heating the water from the entry tube while cooling the water in the intermediate tube. In some embodiments, the splitter may be connected to the intermediate tube. The splitter can remove excess water from the system, by directing any excess water to an external reservoir or for external use, while maintaining a minimum of water in the system for use in passing through the nozzles to assist in the condensation process.

In some embodiments, the flow control element may be present on one or more of the tubes and portions of the system. The flow control element may be computer controlled, limiting or increasing the amount of fluid flow through the system to assist in achieving the optimal rate of fluid flow for most efficient distillation.

The pressure valve may be present on the body of the condensing container. The pressure valve will open or close to help reset the pressure of the condensing chamber to that of the surrounding atmosphere. In some embodiments, the pressure valve may open or closed based on the pressure release whistle.

The pressure release whistle will indicate when the pressure in the condensing chamber has passed a threshold (either too low or too high) and will emit a sound or notification to alert a user or operator that the pressure has passed a certain threshold. In some embodiments, the activation of the pressure release whistle may automatically open the pressure valve to prevent pressure from reaching critical levels.

The pressure gradient created by the vacuum pump assists in cycling the water through the system. By lowering the pressure in the central condensing chamber, steam naturally is drawn from the evaporator into the condensing chamber to fill the void. Further altering the pressure in the condensing chamber, such as by repressurizing the condensing chamber, will assist in condensing the steam into water. The falling water droplets from the nozzles further cool the air and provide a point for the condensing steam to adhere to and fall to the water reservoir. The system achieves further efficiency by transferring heat between the photovoltaic panels, the entry tube, and the intermediate tube. This cools solar panels and water in the intermediate tube while warming the water in the entry tube, reducing the need for cooling of the intermediate tube and reducing the energy needed to heat the water in the evaporator to reach the boiling point.

The temperature of water falling into the water reservoir provides a simple measure of the amount of water vapor that has been drawn into the cycle of the system. If T1 is the temperature of the incoming rain from the nozzle, T2 is the temperature of the water producing water vapor or steam, and T3 is the temperature of the water exiting the condensing chamber, then the fraction of newly collected water relative to the volume that enters the collector is given by (T3−T2)/(T2−T1). Analysis of distilled water yields taken together with these temperature measurements allows for straightforward manipulations, for example, liquid flow rates and water heating to maximize overall efficiencies. The liquid flow rates may be regulated using the flow control element.

### BRIEF DESCRIPTION OF THE DRAWINGS

FIG. 1 is a perspective view of the present invention.

FIG. 2 is a front view of the present invention.

FIG. 3 is a front view of an alternate embodiment of the present invention.

FIG. 4 is a perspective view of an alternate embodiment of the present invention.

FIG. 5 is a system diagram of an embodiment of the present invention.

### DETAIL DESCRIPTIONS OF THE INVENTION

All illustrations of the drawings are for the purpose of describing selected versions of the present invention and are not intended to limit the scope of the present invention.

Unless otherwise explicitly stated, the following definitions should control the meaning of terms later used in this document. The words “a”, “an” and “the” should be understood to include a reference to either one or multiple of a components. For example, “a” component may be read to include “one”, “at least one”, and “a plurality of” the component. The term “water source” should be construed to encompass any fluid, not just water. Likewise, the terms “water” or “salt water” should be construed to include any fluid, and are merely used for the purpose of demonstrating a common use case for distillation of salt water. It should be understood that the term “tube” should be construed to include reference to a pipe or any similar mechanism for fluid transport that is well known in the art.

The present invention is a seawater distillation system. The seawater distillation system may comprise an evaporator 100, a condensing chamber 200, an entry tube 300, an intermediate tube 400, a water reservoir 500, a splitter 600, a photovoltaic panel 700, a vacuum pump 800, a system exit point 900, a flow control element 1000, a pressure release whistle 1100, and a pressure valve 1200.

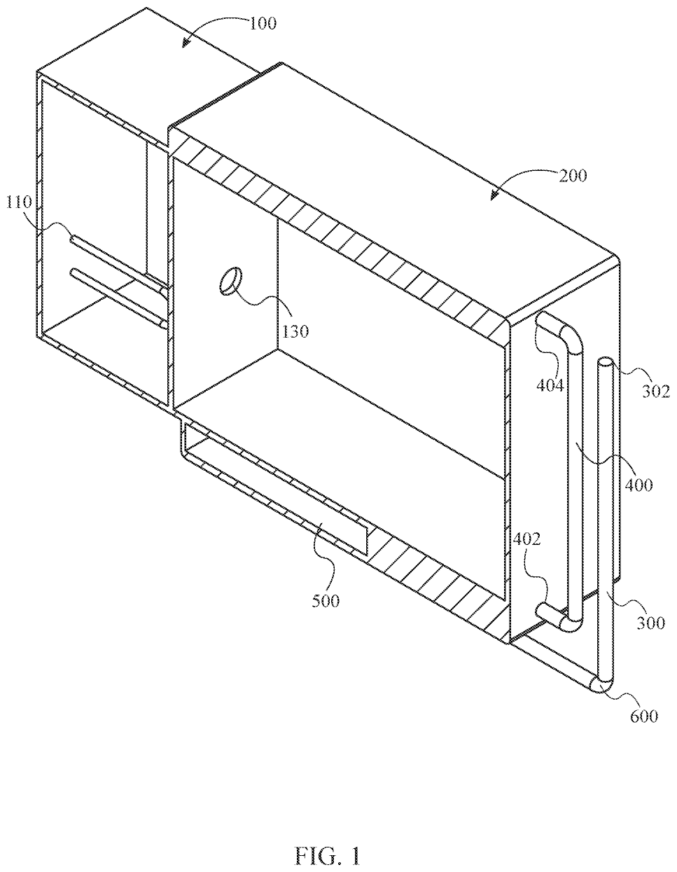

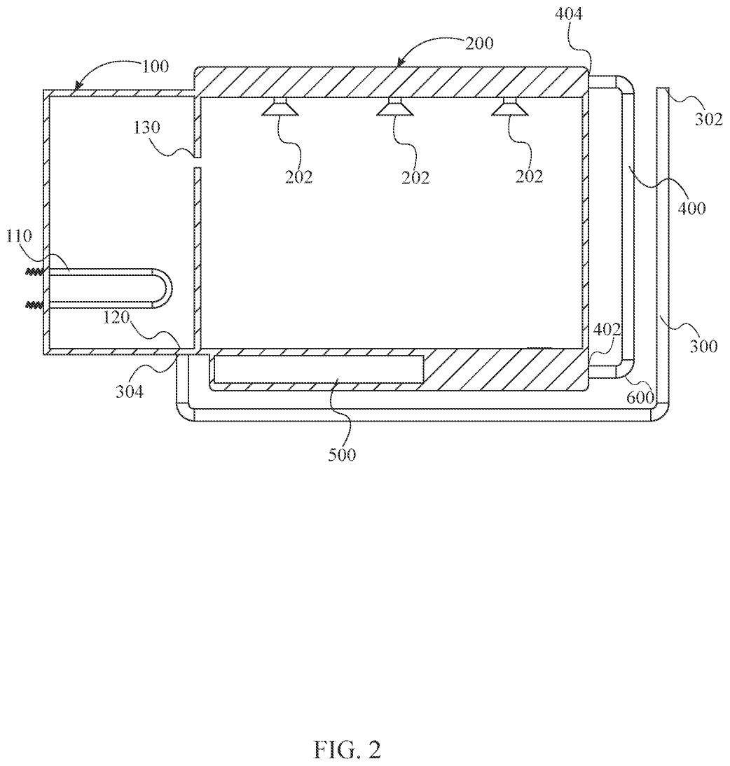

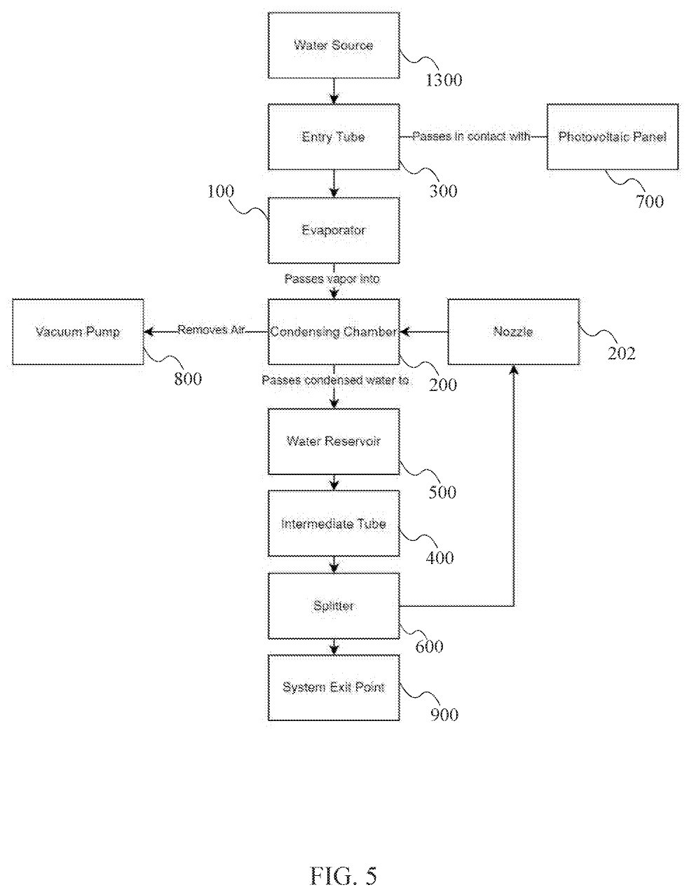

Referring now to FIGS. 1-2 and FIG. 5, the evaporator 100 may comprise a heating element 110, a first evaporator entry point 120, and a first evaporator exit point 130. The interior of the evaporator 100 may be adapted to hold a heated fluid, such that the evaporator 100 is made from a waterproof, heat-tolerant material. The heating element 110 may comprise a heating coil or any heating mechanism well-known in the art for transmitting heat to fluids. The heating element 110 may be adapted to bring a fluid to the boiling point of the fluid. Ideally, the heating element 110 is adapted to bring salt water to a boil to transform the water into steam, leaving the salt and brine behind. The first evaporator entry point 120 is adapted to be in fluid communication with the entry tube 300, such that water may flow from the entry tube 300 into the interior of the evaporator 100. The first evaporator exit point 130 may be adapted to be in fluid or gaseous communication with the condensing chamber 200, such that steam from the evaporator 100 may be transmitted into the condensing chamber 200.

The condensing chamber 200 may comprise a pressure-tolerant container and a nozzle 202. The pressure-tolerant chamber may be a box, container, or other chamber well-known in the art. The condensing chamber 200 may be in the shape of a rectangular prism, cylinder, or other shape. In the ideal embodiment, the water reservoir 500 may be positioned directly beneath the condensing chamber 200, such that the water reservoir 500 is in fluid communication with the condensing chamber 200, either though one or more holes, or a permeable surface. The nozzle 202 may be positioned at the top of the condensing chamber 200. The nozzle 202 is adapted to spray water into the condensing chamber 200. In the ideal embodiment, the nozzle 202 is adapted to be in fluid communication with the intermediate tube 400. The condensing chamber 200 is ideally pressure-tolerant, able to withstand fluctuations in internal and external pressure as necessary to change the condensing environment. The use of more than one nozzle 202 is considered within the spirit and scope of the present invention. It should be understood that he condensing chamber 200 need not necessarily refer to an enclosed compartment; the condensing chamber 200 could be a region within a large pressure-tolerant evaporation structure having a ceiling containing one or more nozzles 202, which serve as water droplet dispensers. At the bottom of the structure, one or more distilled water collectors or water reservoirs 500 would be vertically aligned with the one or more nozzles 202 at the top.

The entry tube 300 may comprise a first entry tube end 302 and a second entry tube end 304. The first entry tube end 302 may be adapted to be in fluid communication with a water source 1300. The second entry tube end 304 may be adapted to be in fluid communication with the evaporator 100. In the ideal embodiment, the entry tube 300 is thus configured to transfer fluid from the water source 1300 into the evaporator 100. In the ideal embodiment, the second entry tube end 304 may be adapted to connect to the first evaporator entry point 120.

The intermediate tube 400 may comprise a first intermediate tube end 402 and a second intermediate tube end 402. The first intermediate tube end 402 may be adapted to be in fluid communication with the water reservoir 500. The second intermediate tube end 402 may be adapted to be in fluid communication with the nozzle 202. In this configuration, the intermediate tube 400 is configured to transmit water from the water reservoir 500 into the nozzle 202. In some embodiment, the intermediate tube 400 may be positioned adjacent to the entry tube 300 to allow for direct heat transfer between the entry tube 300 and the intermediate tube 400. This allows the heat from the fluid in the intermediate tube 400 to be transmitted to the incoming fluid in the entry tube 300. This assists with heating up the incoming water, reducing the energy required to transform the incoming salt water in the entry tube 300 once it reaches the evaporator 100, while simultaneously lowering the temperature of the water in the intermediate tube 400 to assist in the condensing process in the condensation chamber.

The water reservoir 500 may comprise a container or chamber for storing water. The water reservoir 500 is ideally waterproof, and may be adapted to be in fluid communication with the condensing chamber 200 and the intermediate tube 400. In the ideal embodiment, distilled water may flow into the water reservoir 500 from the condensing chamber 200, and the pressure-gradient or a pump will force the water up through the intermediate tube 400 into the nozzles 202.

The splitter 600 may comprise any device well-known in the art for splitting the flow of a fluid into two separate directions. In the ideal embodiment, the splitter 600 is adapted to be in fluid communication with the water reservoir 500, the intermediate tube 400, and the system exit point 900. With this configuration, water enters the splitter 600 from the water reservoir 500, and a portion of the water continues into the intermediate tube 400, while the rest of the water is directed to the system exit point 900 for storage or use. In some embodiments, the splitter 600 may be positioned directly on the intermediate tube 400, such that the splitter 600 is only indirectly in fluid communication with the water reservoir 500 through the intermediate tube 400.

In some embodiments, the system may further comprise a photovoltaic panel 700. The photovoltaic panel 700 may be adapted to provide energy to the seawater distillation system, or may be provided to route energy elsewhere. In the ideal embodiment, the photovoltaic panel 700 may be positioned over the entry tube 300. As photovoltaic panels 700 absorb a great deal of heat from the sun, this configuration allows the water in the entry tube 300 to be naturally heated before entering the evaporator 100, reducing the amount of energy required for the incoming water to reach the boiling point. Likewise, the photovoltaic panel 700 is simultaneously cooled by this heat transfer, preventing the photovoltaic panel 700 from overheating.

The vacuum pump 800 may comprise any vacuum device capable of removing air from a space that is well-known in the art. In the ideal embodiment, the vacuum pump 800 is adapted to be in fluid or gaseous communication with the condensing chamber 200. The vacuum pump 800 is adapted to remove air from the condensing chamber 200 to lower the pressure in the interior of the condensing chamber 200. By lowering the pressure, condensation of the steam is made much easier, which speeds up the distillation process.

The system exit point 900 may be any exit point for removing water from the water distillation system. The system exit point 900 may be a system exit tube leading to an external water storage or similar exit point for the distilled water. In the ideal embodiment, excess water is removed from the condensing chamber 200, water reservoir 500, and intermediate pipe and is transmitted to the system exit point 900 for storage and future use.

In some embodiments, the seawater distillation system may further comprise a water source 1300. The water source 1300 may be the sea, a salt water lake, an artificial water source 1300 that is manually refilled, or any similar source of fluid to feed into the evaporator 100, the fluid ideally being salt water. The entry tube 300 is adapted to pull water from the water source 1300, either through a pump or by using a pressure differential.

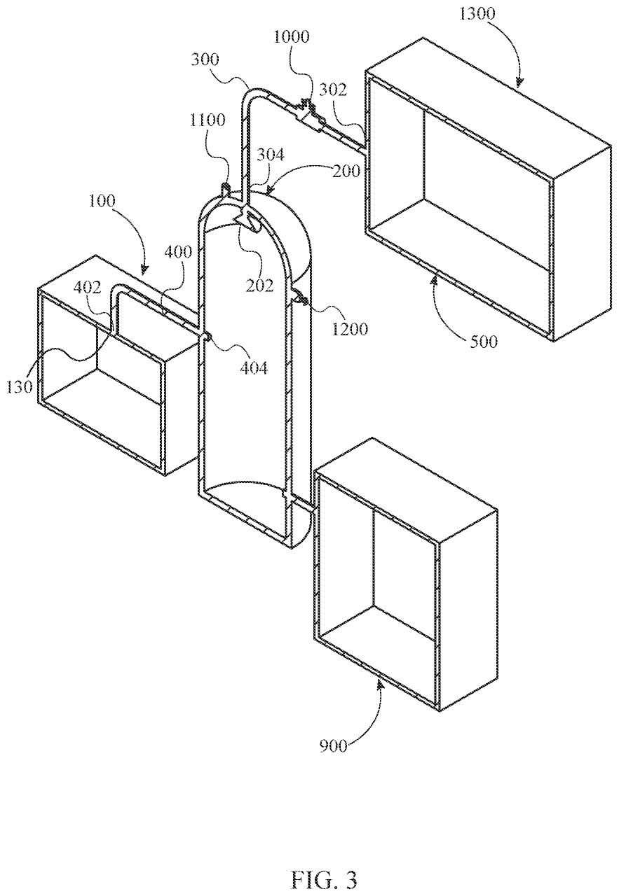

Referring now to FIGS. 3-4 and FIG. 5, the flow control element 1000 may comprise any flow control device to restrict the flow of water that is well-known in the art. The flow control element 1000 is ideally positioned on the entry tube 300, being adapted to control the flow of water through the entry tube 300, such as by narrowing the tube diameter or otherwise restricting the flow of water through the entry tube 300. This allows the rate of fluid flow through the system to be more easily controlled. In some embodiments, one or more flow control elements 1000 may be used to control the flow of water through different portions of the system, such as controlling the flow on the intermediate tube 400. The flow controller may be computer-controlled to optimize evaporation and distillation rates.

The pressure release whistle 1100 may be positioned on the condensing chamber 200. The pressure release whistle 1100 may be adapted to detect when the pressure is below or above a threshold and produce a sound if a pressure beyond the threshold is detected.

The pressure valve 1200 may be positioned on the condensing chamber 200. The pressure valve 1200 is adapted to be switched between an open and shut position. When in a shut position, the pressure valve 1200 is sealed and will not permit any fluid or gas to escape the condensing chamber 200. When in an open position, the pressure valve 1200 permits fluid or gaseous communication between the condensing chamber 200 and the surrounding air. In some embodiments, the pressure valve 1200 may be configured to operate automatically when the pressure release whistle 1100 detects that the pressure is beyond a threshold pressure.

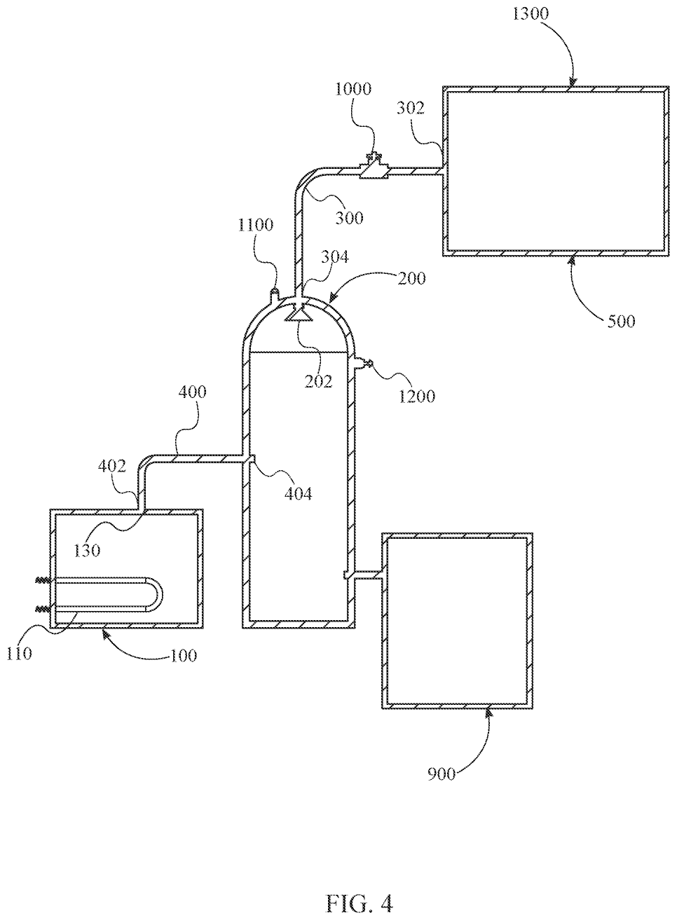

The embodiment shown in FIGS. 3-4 may be a closed system, not connected to an external water source 1300 such as the ocean. In this embodiment, the condensing chamber 200 may be cylindrical in shape with a single nozzle 202 placed in the center top of the condensing chamber 200. The evaporator 100 and nozzle 202 may use a separate water source 1300, rather than having the water from the water reservoir 500 in the condensing chamber 200 circulate back into the nozzle 202 for reuse. For example, the nozzle 202 may connected directly to the entry tube 300, and the evaporator 100 may be connected to the condensing chamber 200 using the intermediate tube 400. The condensing chamber 200 is then connected to the water reservoir 500, which serves as the system exit point 900. This embodiment would need more manual maintenance to keep the intake water source 1300 refilled, but has the advantage of being more portable and not needing direct connection to a renewable or sustainable water source 1300.

A method of use of the present invention is described herein. Water is first pulled from the water source 1300, such as by using a pump, by creating a pressure differential, or similar water flow control mechanism as is well known in the art. The water is then transmitted through the entry tube 300 and into the evaporator 100. In some embodiments, the entry tube may pass in contact with the intermediate tube 400, simultaneously cooling the water in the intermediate tube 400 while heating the water in the entry tube 300. In some embodiments, the entry tube 300 may further pass under or over a photovoltaic panel 700, simultaneously cooling the photovoltaic panel 700 and heating the water in the entry tube 300, while also cleaning the photovoltaic panel 700.

The heating element in the evaporator 100 heats the water to boiling, transforming the water into a gaseous state as water vapor. The water vapor is then communicated to the condensing chamber 200 through the first evaporator 100 exit point. Before the water vapor is communicated to the condensing chamber 200, the vacuum pump 700 may be activated to remove air from the condensing chamber 200, lowering the pressure.

In the condensing chamber 200, distilled water falls from the nozzle 202 at the top of the condensing chamber 200. As the cool distilled water falls, the water vapor in the air condenses onto the droplets as they fall. In some embodiments, the vacuum pump 700 may be used to further alter the pressure during this process to assist in the condensation process, raising or lowering the pressure as needed to optimize the condensing point of the vapor or gas.

Once the condensed water falls to the bottom of the chamber, the condensed water is transmitted to the water reservoir 500, such as through a permeable surface or using gravity, a pump, or other force. The water in the water reservoir 500 will naturally bias upwards through the intermediate tube 400, being transmitted upwards towards the nozzle 202. If necessary, further pumping or similar forces may be applied to move the water from the water reservoir 500 to the nozzle 202.

In order to remove water from the loop in the condensing chamber 200, the splitter 600 may direct excess water out of the intermediate tube 400 or water reservoir 500 and into the system exit point 900.

In some embodiments, the flow control element 1000 may control the rate of fluid flow through the system during the above process. The flow control element 1000 may be computer controlled to automatically optimize the rate of flow for the most efficient or fastest distillation.

The pressure release whistle 1100 may monitor the pressure of the system or the condensing chamber 200 during the above process. If the pressure passes a certain threshold, the pressure release whistle 1100 may emit a sound to alert an operator to a dangerously high or low pressure.

The pressure valve 1200 may be actuated at any point during the above process to return the condensing chamber 200 to a state of atmospheric pressure. In some embodiments, the pressure valve 1200 may be automatically actuated when the pressure release whistle 1100 detects that the pressure has surpassed a certain threshold.

The precise details and order of the steps above may be altered while remaining within the spirit and scope of the present invention.

Although the invention has been explained in relation to its preferred embodiment, it is to be understood that many other possible modifications and variations can be made without departing from the spirit and scope of the invention.

I claim:

1. A water distillation system comprising:
an evaporator;
the evaporator further comprising a heating element;
a condensing chamber;
the condensing chamber being adapted to be pressure-tolerant;
the evaporator being in gaseous communication with the condensing chamber;
a nozzle;
a reservoir;
the nozzle being positioned inside the condensing chamber;
an entry tube comprising a first entry tube end and a second entry tube end;
the first entry tube end being in fluid communication with a water source;
the second entry tube end being in fluid communication with the evaporator;
an intermediate tube;
the intermediate tube comprising a first intermediate tube end and a second intermediate tube end;
the first intermediate tube end being in fluid communication with the reservoir; and
the second intermediate tube end being in fluid communication with the nozzle.

2. The water distillation system of claim 1, further comprising:
a vacuum pump; and
the vacuum pump being in gaseous communication with the condensing chamber, such that the vacuum pump is adapted to remove air from the condensing chamber.

3. The water distillation system of claim 1, further comprising:
a system exit point;
a splitter; and
the splitter being adapted to be in fluid communication with the intermediate tube and the system exit point, such that the splitter is adapted to remove excess distilled water from the water distillation system by transferring excess water to the system exit point.

4. The water distillation system of claim 1, further comprising:
the evaporator being adapted to hold a heated fluid; and
the evaporator further comprising a first evaporator entry point and a first evaporator exit point.

5. The water distillation system of claim 4, further comprising:
the first evaporator exit point being in gaseous communication with the condensing chamber; and
the first evaporator entry point being in fluid communication with the entry tube.

6. The water distillation system of claim 1, further comprising:
the intermediate tube being positioned adjacent to the entry tube, such that that intermediate tube and entry tube are configured to permit heat transfer.

7. The water distillation system of claim 1, further comprising:
a photovoltaic panel; and
the entry tube being adapted to be adjacent to the photovoltaic panel, such that the entry tube and photovoltaic panel are configured to permit heat transfer.

8. The water distillation system of claim 1, further comprising:
a flow control element;
a pressure release whistle; and
a pressure valve.

9. The water distillation system of claim 8, further comprising:
the flow control element being positioned on the entry tube; and
the flow control element being adapted to control the rate of fluid flow through the entry tube.

10. The water distillation system of claim 8, further comprising:
the pressure release whistle being positioned on the condensing chamber; and
the pressure release whistle being adapted to produce a sound when the pressure in the condensing chamber passes a threshold value.

11. The water distillation system of claim 8, further comprising:
the pressure valve being positioned on the condensing chamber; and
the pressure valve being adapted to selectively release pressure from the condensing chamber.

12. The water distillation system of claim 1, further comprising:
the nozzle being positioned inside the top of the condensing chamber such that water from the nozzle falls from the top of the condensing chamber to the bottom of the condensing chamber.

13. A water distillation system comprising:
an evaporator;
the evaporator further comprising a heating element;
the evaporator being adapted to hold a heated fluid;
the evaporator further comprising a first evaporator entry point and a first evaporator exit point;
a condensing chamber;
the condensing chamber being adapted to be pressure-tolerant;
the first evaporator exit point being in gaseous communication with the condensing chamber;
the first evaporator entry point being in fluid communication with the entry tube;
a nozzle;
a reservoir;
an intermediate tube;
the intermediate tube comprising a first intermediate tube end and a second intermediate tube end;
the nozzle being positioned inside the top of the condensing chamber such that water from the nozzle falls from the top of the condensing chamber to the bottom of the condensing chamber;
an entry tube comprising a first entry tube end and a second entry tube end;
the first entry tube end being in fluid communication with a water source;
the second entry tube end being in fluid communication with the evaporator;
the first intermediate tube end being in fluid communication with the reservoir;
the second intermediate tube end being in fluid communication with the nozzle; and
the intermediate tube being positioned adjacent to the entry tube, such that that intermediate tube and entry tube are configured to permit heat transfer.

14. The water distillation system of claim 13, further comprising:
a vacuum pump; and
the vacuum pump being in gaseous communication with the condensing chamber, such that the vacuum pump is adapted to remove air from the condensing chamber.

15. The water distillation system of claim 13, further comprising:
a flow control element;
a pressure release whistle; and
a pressure valve.

16. The water distillation system of claim 15, further comprising:
the flow control element being positioned on the entry tube; and
the flow control element being adapted to control the rate of fluid flow through the entry tube.

17. The water distillation system of claim 13, further comprising:
the pressure release whistle being positioned on the condensing chamber;
the pressure release whistle being adapted to produce a sound when the pressure in the condensing chamber passes a threshold value;
the pressure valve being positioned on the condensing chamber; and
the pressure valve being adapted to selectively release pressure from the condensing chamber.

18. The water distillation system of claim 13, further comprising:
a photovoltaic panel; and
the entry tube being adapted to be adjacent to the photovoltaic panel, such that the entry tube and photovoltaic panel are configured to permit heat transfer.

19. The water distillation system of claim 13, further comprising:
a system exit point;
a splitter; and
the splitter being adapted to be in fluid communication with the intermediate tube and the system exit point, such that the splitter is adapted to remove excess distilled water from the water distillation system by transferring excess water to the system exit point.

20. A water distillation system comprising:
an evaporator;
the evaporator further comprising a heating element;
the evaporator being adapted to hold a heated fluid;
the evaporator further comprising a first evaporator entry point and a first evaporator exit point;
a condensing chamber;
a vacuum pump;
the vacuum pump being in gaseous communication with the condensing chamber, such that the vacuum pump is adapted to remove air from the condensing chamber;
the condensing chamber being adapted to be pressure-tolerant;
the first evaporator exit point being in gaseous communication with the condensing chamber;
the first evaporator entry point being in fluid communication with the entry tube;
a nozzle;
a reservoir;
an intermediate tube;
a system exit point;
a splitter;
a flow control element;
a pressure release whistle;
a pressure valve;
the flow control element being positioned on the entry tube;
the flow control element being adapted to control the rate of fluid flow through the entry tube;
the pressure release whistle being positioned on the condensing chamber;
the pressure release whistle being adapted to produce a sound when the pressure in the condensing chamber passes a threshold value;
the pressure valve being positioned on the condensing chamber;
the pressure valve being adapted to selectively release pressure from the condensing chamber;
the nozzle being positioned inside the top of the condensing chamber such that water from the nozzle falls from the top of the condensing chamber to the bottom of the condensing chamber;
an entry tube comprising a first entry tube end and a second entry tube end;
the first entry tube end being in fluid communication with a water source;
the second entry tube end being in fluid communication with the evaporator;
a photovoltaic panel;
the entry tube being adapted to be adjacent to the photovoltaic panel, such that the entry tube and photovoltaic panel are configured to permit heat transfer;
the intermediate tube comprising a first intermediate tube end and a second intermediate tube end;
the first intermediate tube end being in fluid communication with the reservoir;
the splitter being adapted to be in fluid communication with the intermediate tube and the system exit point, such that the splitter is adapted to remove excess distilled water from the water distillation system by transferring excess water to the system exit point;
the intermediate tube being positioned adjacent to the entry tube, such that that intermediate tube and entry tube are configured to permit heat transfer; and
the second intermediate tube end being in fluid communication with the nozzle.
